(19) United States
(12) Patent Application Publication
(10) Pub. No.: US 2023/0084939 A1
(43) Pub. Date: Mar. 16, 2023

(54) ARTICLES HAVING POLYMER FILM LAYERS

(71) Applicant: DUPONT ELECTRONICS, INC., Wilmington, DE (US)

(72) Inventors: Kostantinos Kourtakis, Media, PA (US); Benjamin Samson, Wilmington, DE (US); Dennis Walls, Wilmington, DE (US); Neng Xiao, Bear, DE (US); Lei Zhang, Hockessin (DE)

(21) Appl. No.: 17/903,775

(22) Filed: Sep. 6, 2022

Related U.S. Application Data
(60) Provisional application No. 63/244,570, filed on Sep. 15, 2021.

(51) Int. Cl. C08G 73/10; B32B 3/02; B32B 27/08; B32B 27/28; B32B 27/34; B32B 27/36; B32B 27/16

(52) U.S. Cl. CPC C08G 73/1067; B32B 3/02; B32B 27/08; B32B 27/281; B32B 27/34; B32B 27/36; B32B 27/16; B32B 17/10

(57) ABSTRACT

In a first aspect, an article includes a first polymer film layer and a second polymer film layer. The first polymer film layer includes a first polymer including a first imide group. The second polymer film layer includes a second polymer including a second imide group.

### FIELD OF DISCLOSURE

The field of this disclosure is articles having polymer film layers.

### BACKGROUND OF THE DISCLOSURE

Articles having polymer film layers are used in a wide variety of applications that take advantage of the wide range of mechanical, electrical, optical and other properties that polymers can provide. Inorganic (e.g., ceramic and glass) laminated products have long been used for a wide variety of applications, such as armor for buildings, vehicles and personnel, as well as safety glass for transparent applications. Beyond the well-known, every day automotive safety glass used in windshields, laminated glass is used as windows for trains, airplanes, ships, and nearly every other mode of transportation. Safety glass is characterized by high impact and penetration resistance and does not scatter glass shards and debris when shattered.

Safety glass typically consists of a sandwich of two glass sheets or panels bonded together with an interlayer of a polymeric film or sheet, which is placed between the two glass sheets. One or both glass sheets may be replaced with optically clear rigid polymeric sheets, such as sheets of polycarbonate materials. Safety glass has further evolved to include multiple layers of glass and polymeric sheets bonded together with interlayers of polymeric films or sheets.

The interlayer is typically a relatively thick polymer sheet, which exhibits toughness and bondability to provide adhesion to the glass in the event of a crack or crash. In general, it is desirable that these polymeric interlayers possess a combination of characteristics including very high optical clarity, low haze, high impact resistance, high penetration resistance, excellent ultraviolet light resistance, good long-term thermal stability, excellent adhesion to glass and other rigid polymeric sheets, low ultraviolet light transmittance, low moisture absorption, high moisture resistance, and excellent long term weatherability, among other requirements.

A recent trend has been the use of glass-laminated products in the construction of homes and office structures. The use of architectural glass has expanded rapidly over the years as designers incorporate more glass surfaces into buildings. Threat resistance has become an ever-increasing requirement for architectural glass laminated products. These newer products are designed to resist both natural and man-made disasters. Examples of these needs include the recent developments of hurricane resistant glass, now mandated in hurricane susceptible areas, theft resistant glazings, and the more recent blast resistant glass-laminated products designed to protect buildings and their occupants. Some of these products have great enough strength to resist intrusion even after the glass laminate has been broken; for example, when a glass laminate is subjected to high force winds and impacts of flying debris, which can occur in a hurricane, or where there are repeated impacts on a window by a criminal attempting to break into a vehicle or structure.

A smooth glass surface presents a challenge for adhering a polymer layer without the use of adhesives. Silanization is a well know method for introducing a variety of functional groups onto a glass surface. For example, a coating solution having an amino-functional silane coupling agent can be deposited onto a glass substrate and dried to remove the solvent, resulting in a glass surface with a modified surface energy.

Polyimide films can be adhered to inorganic substrates, such as silicon substrates, by coating a polyamic acid solution onto a silicon substrate that has been functionalized using an amino-functional silane coupling agent (A. V. Patsis and S. Cheng, J Adhesion (1988), 25, 145-157). When the solution is applied to the treated surface, the silane coupling agent interacts with the amic acid through interactions between carboxylic acid and amine groups on the polyamic acid and silanol groups on the silicon substrate. During subsequent curing, the polyamic acid is converted to the polyimide.

Polymer film layers are also used extensively in electronic devices at the circuit level, as well as for outer device layers, such as in display devices. When two or more polymer layers are desired, a multilayer polymer film construction with good adhesion can be made by coextruding the polymer layers, or by using coating techniques. For instance, polyamic acid, or soluble polyimide, compositions can be coextruded and cured to form a multilayer polyimide film, or successive coatings of polyamic acid, or soluble polyimide, compositions can be sequentially deposited to form a multilayer film.

### SUMMARY

In a first aspect, an article includes a first polymer film layer and a second polymer film layer. The first polymer film layer includes a first polymer including a first imide group. The second polymer film layer includes a second polymer including a second imide group. After separating the first and second polymer film layers at an interface between the layers to expose a first interfacial surface of the first polymer film layer and a second interfacial surface of the second polymer film layer:
(a) a ratio of CN⁻ to C₃N⁻ species at the first interfacial surface, as measured using negative secondary ion mass spectroscopy is at least 10% higher than it is in the bulk of the first polymer film layer;
(b) a ratio of CN⁻ to C₃N⁻ species at the second interfacial surface, as measured using negative secondary ion mass spectroscopy is at least 10% higher than it is in the bulk of the second polymer film layer; or
(c) a ratio of CN⁻ to C₃N⁻ species at the first interfacial surface, as measured using negative secondary ion mass spectroscopy is at least 10% higher than it is in the bulk of the first polymer film layer and a ratio of CN⁻ to C₃N⁻ species at the second interfacial surface, as measured using negative secondary ion mass spectroscopy is at least 10% higher than it is in the bulk of the second polymer film layer.

In a second aspect, an impact-resistant article includes the article of the first aspect.

In a third aspect, a penetration-resistant article includes the article of the first aspect.

In a fourth aspect, a sound-reducing article includes the article of the first aspect.

In a fifth aspect, a metal-clad laminate includes the article of the first aspect.

In a sixth aspect, a process for forming an article is described. The article includes a first polymer film layer including a first polymer having a first glass transition temperature and including a first imide group and a second polymer film layer including a second polymer having a second glass transition temperature and including a second imide group, wherein the first glass transition temperature is the same or lower than the second glass transition temperature. The process includes:
(a) applying an amine reagent to a surface of the first polymer film layer, a surface of the second polymer film layer, or both;
(b) contacting the polymer film layers, such that a surface having an amine reagent is at an interface between the polymer film layers; and
(c) applying heat and pressure to the article.

The foregoing general description and the following detailed description are exemplary and explanatory only and are not restrictive of the invention, as defined in the appended claims.

### DETAILED DESCRIPTION

In a first aspect, an article includes a first polymer film layer and a second polymer film layer. The first polymer film layer includes a first polymer including a first imide group. The second polymer film layer includes a second polymer including a second imide group. After separating the first and second polymer film layers at an interface between the layers to expose a first interfacial surface of the first polymer film layer and a second interfacial surface of the second polymer film layer:
(a) a ratio of CN⁻ to C₃N⁻ species at the first interfacial surface, as measured using negative secondary ion mass spectroscopy is at least 10% higher than it is in the bulk of the first polymer film layer;
(b) a ratio of CN⁻ to C₃N⁻ species at the second interfacial surface, as measured using negative secondary ion mass spectroscopy is at least 10% higher than it is in the bulk of the second polymer film layer; or
(c) a ratio of CN⁻ to C₃N⁻ species at the first interfacial surface, as measured using negative secondary ion mass spectroscopy is at least 10% higher than it is in the bulk of the first polymer film layer and a ratio of CN⁻ to C₃N⁻ species at the second interfacial surface, as measured using negative secondary ion mass spectroscopy is at least 10% higher than it is in the bulk of the second polymer film layer.

In one embodiment of the first aspect, the first and second polymers including an imide group are each individually selected from the group consisting of polyimides, poly(amide-imides), poly(ether-imides), poly(ester-imides), copolymers including amide, ester or ether groups, and mixtures thereof. In a specific embodiment, the polyimide is derived from a dianhydride, a fluorinated aromatic diamine and an aliphatic diamine. In a more specific embodiment, the dianhydride includes an alicyclic dianhydride.

In another embodiment of the first aspect, (a) the first polymer film layer has a T_{g} of 300° C. or less; (b) the second polymer film layer has a T_{g} of 300° C. or less; or (c) both the first and second polymer film layers have T_{g}'s of 300° C. or less.

In still another embodiment of the first aspect, the article has a b* of 1.25 or less and a yellowness index of 2.25 or less when measured using the procedure described by ASTM E313 at a thickness of 25 μm.

In yet another embodiment of the first aspect, the article has a haze of 15% or less and an L* of 93 or more when measured at a thickness of 25 μm.

In still yet another embodiment of the first aspect, the article further includes an inorganic substrate in contact with the first polymer film layer on a side opposite the second polymer film layer.

In a second aspect, an impact-resistant article includes the article of the first aspect.

In a third aspect, a penetration-resistant article includes the article of the first aspect.

In a fourth aspect, a sound-reducing article includes the article of the first aspect.

In a fifth aspect, a metal-clad laminate includes the article of the first aspect.

In a sixth aspect, a process for forming an article is described. The article includes a first polymer film layer including a first polymer having a first glass transition temperature and including a first imide group and a second polymer film layer including a second polymer having a second glass transition temperature and including a second imide group, wherein the first glass transition temperature is the same or lower than the second glass transition temperature. The process includes:
(a) applying an amine reagent to a surface of the first polymer film layer, a surface of the second polymer film layer, or both;
(b) contacting the polymer film layers, such that a surface having an amine reagent is at an interface between the polymer film layers; and
(c) applying heat and pressure to the article.

In one embodiment of the sixth aspect, the amine reagent is selected from the group consisting of primary amines, secondary amines, or a mixture thereof.

In another embodiment of the sixth aspect, the amine reagent includes a polyamine.

In still another embodiment of the sixth aspect, the amine reagent includes a metal alkoxide including a hydrolyzed oligomer.

In yet another embodiment of the sixth aspect, the amine reagent applied to the surface of the first polymer film layer is the same or different than the amine reagent applied to the surface of the second polymer film layer.

In still yet another embodiment of the sixth aspect, heat is a temperature in a range of from 20 degrees below to 50 degrees above the glass transition temperature of the first polymer.

In a further embodiment of the sixth aspect, the amine reagent includes an amine group that has been passivated and can be thermally activated by applying heat. In a specific embodiment, the amine group that has been passivated can, upon activation, also crosslink the first polymer, the second polymer, or both.

In still a further embodiment of the sixth aspect, before applying the amine reagent to the surface of one or both polymer film layer(s), the surface of one or both polymer film layer(s) undergoes a corona treatment or a plasma treatment.

In yet a further embodiment of the sixth aspect, the article further includes an inorganic substrate in contact with the first polymer film layer on a side opposite the second polymer film layer. During step (a) of the process, an amine reagent is also applied to the other surface of the first polymer film layer, a surface of the inorganic substrate, or both. During step (b) of the process, the first polymer film layer and the inorganic substrate are contacted such that a surface having an amine reagent is at an interface between the first polymer film layer and the inorganic substrate.

Many aspects and embodiments have been described above and are merely exemplary and not limiting. After reading this specification, skilled artisans appreciate that other aspects and embodiments are possible without departing from the scope of the invention. Other features and advantages of the invention will be apparent from the following detailed description, and from the claims.

Depending upon context, “diamine” as used herein is intended to mean: (i) the unreacted form (i.e., a diamine monomer); (ii) a partially reacted form (i.e., the portion or portions of an oligomer or other polymer precursor derived from or otherwise attributable to diamine monomer) or (iii) a fully reacted form (the portion or portions of the polymer derived from or otherwise attributable to diamine monomer). The diamine can be functionalized with one or more moieties, depending upon the particular embodiment selected in the practice of the present invention.

Indeed, the term “diamine” is not intended to be limiting (or interpreted literally) as to the number of amine moieties in the diamine component. For example, (ii) and (iii) above include polymeric materials that may have two, one, or zero amine moieties. Alternatively, the diamine may be functionalized with additional amine moieties (in addition to the amine moieties at the ends of the monomer that react with dianhydride to propagate a polymeric chain). Such additional amine moieties could be used to crosslink the polymer or to provide other functionality to the polymer.

Similarly, the term “dianhydride” as used herein is intended to mean the component that reacts with (is complimentary to) the diamine and in combination is capable of reacting to form an intermediate (which can then be cured into a polymer). Depending upon context, “anhydride” as used herein can mean not only an anhydride moiety per se, but also a precursor to an anhydride moiety, such as: (i) a pair of carboxylic acid groups (which can be converted to anhydride by a de-watering or similar-type reaction); or (ii) an acid halide (e.g., chloride) ester functionality (or any other functionality presently known or developed in the future which is) capable of conversion to anhydride functionality.

Depending upon context, “dianhydride” can mean: (i) the unreacted form (i.e. a dianhydride monomer, whether the anhydride functionality is in a true anhydride form or a precursor anhydride form, as discussed in the prior above paragraph); (ii) a partially reacted form (i.e., the portion or portions of an oligomer or other partially reacted or precursor polymer composition reacted from or otherwise attributable to dianhydride monomer) or (iii) a fully reacted form (the portion or portions of the polymer derived from or otherwise attributable to dianhydride monomer).

The dianhydride can be functionalized with one or more moieties, depending upon the particular embodiment selected in the practice of the present invention. Indeed, the term “dianhydride” is not intended to be limiting (or interpreted literally) as to the number of anhydride moieties in the dianhydride component. For example, (i), (ii) and (iii) (in the paragraph above) include organic substances that may have two, one, or zero anhydride moieties, depending upon whether the anhydride is in a precursor state or a reacted state. Alternatively, the dianhydride component may be functionalized with additional anhydride type moieties (in addition to the anhydride moieties that react with diamine to provide a polymer). Such additional anhydride moieties could be used to crosslink the polymer or to provide other functionality to the polymer.

Any one of a number of polymer manufacturing processes may be used to prepare polymer films. It would be impossible to discuss or describe all possible manufacturing processes useful in the practice of the present invention. It should be appreciated that the monomer systems of the present invention are capable of providing the above-described advantageous properties in a variety of manufacturing processes. The compositions of the present invention can be manufactured as described herein and can be readily manufactured in any one of many (perhaps countless) ways of those of ordinarily skilled in the art, using any conventional or non-conventional manufacturing technology.

Although methods and materials similar or equivalent to those described herein can be used in the practice or testing of the present invention, suitable methods and materials are described herein.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

In describing certain polymers, it should be understood that sometimes applicants are referring to the polymers by the monomers used to make them or the amounts of the monomers used to make them. Mile such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof.

The materials, methods, and examples herein are illustrative only and, except as specifically stated, are not intended to be limiting.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

### Organic Solvents

Useful organic solvents for the synthesis of the polymers of the present invention are preferably capable of dissolving the polymer precursor materials. Such a solvent should also have a relatively low boiling point, such as below 225° C., so the polymer can be dried at moderate (i.e., more convenient and less costly) temperatures. A boiling point of less than 210, 205, 200, 195, 190, or 180° C. is preferred.

Useful organic solvents include: N-methylpyrrolidone (NMP), dimethylacetamide (DMAc), methyl ethyl ketone (MEK), N,N′-dimethyl-formamide (DMF), dimethyl sulfoxide (DMSO), tetramethyl urea (TMU), glycol ethyl ether, diethyleneglycol diethyl ether, 1,2-dimethoxyethane (monoglyme), diethylene glycol dimethyl ether (diglyme), 1,2-bis-(2-methoxyethoxy) ethane (triglyme), gamma-butyrolactone, and bis-(2-methoxyethyl) ether, tetrahydrofuran (THF), ethyl acetate, hydroxyethyl acetate glycol monoacetate, acetone and mixtures thereof. In one embodiment, preferred solvents include N-methylpyrrolidone (NMP) and dimethylacetamide (DMAc).

### Diamines

In one embodiment, a suitable diamine for forming the polymer can include an aliphatic diamine, such as 1,2-diaminoethane, 1,6-diaminohexane (HMD), 1,4-diaminobutane, 1,5 diaminopentane, 1,7-diaminoheptane, 1,8-diaminooctane, 1,9-diaminononane, 1,10-diaminodecane (DMD), 1,11-diaminoundecane, 1,12-diaminododecane (DDD), 1,16-hexadecamethylenediamine, 1,3-bis(3-aminopropyl)-tetramethyldisiloxane, trans-1,4-diaminocyclohexane (CHDA), isophoronediamine (IPDA), bicyclo[2.2.2]octane-1,4-diamine and combinations thereof. Other aliphatic diamines suitable for practicing the invention include those having six to twelve carbon atoms or a combination of longer chain and shorter chain diamines so long as both developability and flexibility of the polymer are maintained. Long chain aliphatic diamines may increase flexibility.

In one embodiment, a suitable diamine for forming the polymer can include an alicyclic diamine (can be fully or partially saturated), such as a cyclobutane diamine (e.g., cis- and trans-1,3-diaminocyclobutane, 6-amino-3-azaspiro[3.3]heptane, and 3,6-diaminospiro[3.3]heptane), bicyclo[2.2.1]heptane-1,4-diamine, isophoronediamine, and bicyclo[2.2.2]octane-1,4 diamine. Other alicyclic diamines can include cis-1,4 cyclohexane diamine, trans-1,4 cyclohexane diamine, 1,4-bis(aminomethyl)cyclohexane, 4,4′-methylenebis(cyclohexylamine), 4,4′-methylenebis(2-methyl-cyclohexylamine), bis(aminomethyl)norbornane.

In one embodiment, a suitable diamine for forming the polymer can include a fluorinated aromatic diamine, such as 2,2′-bis(trifluoromethyl) benzidine (TFMB), trifluoromethyl-2,4-diaminobenzene, trifluoromethyl-3,5-diaminobenzene, 2,2′-bis-(4-aminophenyl)-hexafluoro propane, 4,4′-diamino-2,2′-trifluoromethyl diphenyloxide, 3,3′-diamino-5,5′-trifluoromethyl diphenyloxide, 9.9′-bis(4-aminophenyl)fluorene, 4,4′-trifluoromethyl-2,2′-diaminobiphenyl, 4,4′-oxy-bis-[2-trifluoromethyl)benzene amine] (1,2,4-OBABTF), 4,4′-oxy-bis-[3-trifluoromethyl)benzene amine], 4,4′-thio-bis-[(2-trifluoromethyl)benzene-amine], 4,4′-thiobis[(3-trifluoromethyl)benzene amine], 4,4′-sulfoxyl-bis-[(2-trifluoromethyl)benzene amine, 4,4′-sulfoxyl-bis-[(3-trifluoromethyl)benzene amine], 4,4′-keto-bis-[(2-trifluoromethyl)benzene amine], 1,1-bis[4′-(4″-amino-2″-trifluoromethylphenoxy)phenyl]cyclopentane, 1,1-bis[4′-(4″-amino-2″-trifluoromethylphenoxy)phenyl]cyclohexane, 2-trifluoromethyl-4,4′-diaminodiphenyl ether; 1,4-(2′-trifluoromethyl-4′,4″-diaminodiphenoxy)-benzene, 1,4-bis(4′-aminophenoxy)-2-[(3′,5′-ditrifluoromethyl)phenyl]benzene, 1,4-bis[2′-cyano-3′(“4-amino phenoxy)phenoxy]-2-[(3′,5′-ditrifluoro-methyl)phenyl]benzene (6FC-diamine), 3,5-diamino-4-methyl-2′,3′,5′,6′-tetrafluoro-4′-tri-fluoromethyldiphenyloxide, 2,2-Bis[4′(4″-aminophenoxy)phenyl]phthalein-3′,5′-bis(trifluoromethyl)anilide (6FADAP) and 3,3′,5,5′-tetrafluoro-4,4′-diamino-diphenylmethane (TFDAM).

Other useful diamines for forming the polymer can include p-phenylenediamine (PPD), m-phenylenediamine (MPD), 2,5-dimethyl-1,4-diaminobenzene, 2,5-dimethyl-1,4-phenylenediamine (DPX), 2,2-bis-(4-aminophenyl) propane, 1,4-naphthalenediamine, 1,5-naphthalenediamine, 4,4′-diaminobiphenyl, 4,4″-diamino terphenyl, 4,4′-diamino benzanilide, 4,4′-diaminophenyl benzoate, 4,4′-diaminobenzophenone, 4,4′-diaminodiphenylmethane (MDA), 4,4′-diaminodiphenyl sulfide, 4,4′-diaminodiphenyl sulfone, 3,3′-diaminodiphenyl sulfone, bis-(4-(4-aminophenoxy)phenyl sulfone (BAPS), 4,4′-bis-(aminophenoxy)biphenyl (BAPB), 4,4′-diaminodiphenyl ether (ODA), 3,4′-diaminodiphenyl ether, 4,4′-diaminobenzophenone, 4,4′-isopropylidenedianiline, 2,2′-bis-(3-aminophenyl)propane, N,N-bis-(4-aminophenyl)-n-butylamine, N,N-bis-(4-aminophenyl) methylamine, 1,5-diaminonaphthalene, 3,3′-dimethyl-4,4′-diaminobiphenyl, m-amino benzoyl-p-amino anilide, 4-aminophenyl-3-aminobenzoate, N,N-bis-(4-aminophenyl) aniline, 2,4-diaminotoluene, 2,5-diaminotoluene, 2,6-diaminotoluene, 2,4-diamine-5-chlorotoluene, 2,4-diamine-6-chlorotoluene, 2,4-bis-(beta-amino-t-butyl) toluene, bis-(p-beta-amino-t-butyl phenyl) ether, p-bis-2-(2-methyl-4-aminopentyl) benzene, m-xylylene diamine, and p-xylylene diamine.

Other useful diamines for forming the polymer can include 1,2-bis-(4-aminophenoxy)benzene, 1,3-bis-(4-aminophenoxy) benzene (RODA), 1,2-bis-(3-aminophenoxy)benzene, 1,3-bis-(3-aminophenoxy) benzene, 1-(4-aminophenoxy)-3-(3-aminophenoxy) benzene, 1,4-bis-(4-aminophenoxy) benzene, 1,4-bis-(3-aminophenoxy) benzene, 1-(4-aminophenoxy)-4-(3-aminophenoxy) benzene, 2,2-bis-(4-[4-aminophenoxy]phenyl) propane (BAPP), 2,2′-bis-(4-phenoxy aniline) isopropylidene, 2,4,6-trimethyl-1,3-diaminobenzene and 2,4,6-trimethyl-1,3-diaminobenzene.

### Dianhydrides

In one embodiment, any number of suitable dianhydrides can be used in forming the polymer. The dianhydrides can be used in their tetra-acid form (or as mono, di, tri, or tetra esters of the tetra acid), or as their diester acid halides (chlorides). However, in some embodiments, the dianhydride form can be preferred, because it is generally more reactive than the acid or the ester.

Examples of suitable dianhydrides include 3,3′,4,4′-biphenyltetracarboxylic dianhydride (BPDA), 1,2,5,6-naphthalene tetracarboxylic dianhydride, 1,4,5,8-naphthalene tetracarboxylic dianhydride, 2,3,6,7-naphthalene tetracarboxylic dianhydride, 2-(3′,4′-dicarboxyphenyl) 5,6-dicarboxybenzimidazole dianhydride, 2-(3′,4′-dicarboxyphenyl) 5,6-dicarboxybenzoxazole dianhydride, 2-(3′,4′-dicarboxyphenyl) 5,6-dicarboxybenzothiazole dianhydride, 2,2′,3,3′-benzophenone tetracarboxylic dianhydride, 2,3,3′,4′-benzophenone tetracarboxylic dianhydride, 3,3′,4,4′-benzophenone tetracarboxylic dianhydride (BTDA), 2,2′,3,3′-biphenyltetracarboxylic dianhydride, 2,3,3′,4′-biphenyltetracarboxylic dianhydride, bicyclo-[2,2,2]-octen-(7)-2,3,5,6-tetracarboxylic-2,3,5,6-dianhydride, 4,4′-thio-diphthalic anhydride, bis (3,4-dicarboxyphenyl) sulfone dianhydride, bis (3,4-dicarboxyphenyl) sulfoxide dianhydride (DSDA), bis (3,4-dicarboxyphenyl oxadiazole-1,3,4) p-phenylene dianhydride, bis (3,4-dicarboxyphenyl) 2,5-oxadiazole 1,3,4-dianhydride, bis 2,5-(3′,4′-dicarboxydiphenylether) 1,3,4-oxadiazole dianhydride, 4,4′-oxydiphthalic anhydride (ODPA), bis (3,4-dicarboxyphenyl) thio ether dianhydride, bisphenol A dianhydride (BPADA), bisphenol S dianhydride, bis-1,3-isobenzofurandione, 1,4-bis(4,4′-oxyphthalic anhydride) benzene, bis (3,4-dicarboxyphenyl) methane dianhydride, cyclopentadienyl tetracarboxylic dianhydride, ethylene tetracarboxylic dianhydride, perylene 3,4,9,10-tetracarboxylic dianhydride, pyromellitic dianhydride (PMDA), tetrahydrofuran tetracarboxylic dianhydride, 1,3-bis-(4,4′-oxydiphthalic anhydride) benzene, 2,2-bis(3,4-dicarboxyphenyl)propane dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-1,8,9,10-tetracarboxylic dianhydride, pyrazine-2,3,5,6-tetracarboxylic dianhydride, benzene-1,2,3,4-tetracarboxylic dianhydride and thiophene-2,3,4,5-tetracarboxylic dianhydride.

In one embodiment, a suitable dianhydride can include an alicyclic dianhydride, such as cyclobutane-1,2,3,4-tetracarboxylic diandydride (CBDA), 1,2,4,5-cyclohexanetetracarboxylic dianhydride, 1,2,3,4-cyclohexanetetracarboxylic dianhydride, 1,2,3,4-tetramethyl-1,2,3,4-cyclobutanetetracarboxylic dianhydride, 1,2,3,4-cyclopentanetetracarboxylic dianhydride (CPDA), hexahydro-4,8-ethano-1H,3H-benzo[1,2-c:4,5-c′]difuran-1,3,5,7-tetrone (BODA), 3-(carboxymethyl)-1,2,4-cyclopentanetricarboxylic 1,4:2,3-dianhydride (TCA), and meso-butane-1,2,3,4-tetracarboxylic dianhydride. In one embodiment, an alicyclic dianhydride can be present in an amount of about 70 mole percent or less, based on the total dianhydride content of the polymer.

In one embodiment, a suitable dianhydride for forming the polymer can include a fluorinated dianhydride, such as 4,4′-(hexafluoroisopropylidene)diphthalic anhydride (6FDA) and 9,9-bis (trifuoromethyl)-2,3,6,7-xanthene tetracarboxylic dianhydride.

In one embodiment, poly(amide-imides) can be produced from acyl chloride-containing monomers such as terephthaloyl chloride (TPCI), isophthaloyl chloride (IPCI), biphenyl dicarbonyl chloride (BPCI), naphthalene dicarbonyl chloride, terphenyl dicarbonyl chloride, 2-fluoro-terephthaloyl chloride and trimellitic anhydride.

In one embodiment, poly(ester-imides) can be produced from polyols which can react with carboxylic acid or the ester acid halides to generate ester linkages.

The dihydric alcohol component may be almost any alcoholic diol containing two esterifiable hydroxyl groups. Mixtures of suitable diols may also be included. Suitable diols for use herein include for example, ethylene glycol, propylene glycol, 1,4-butane diol, 1,5-pentane diol, neopenty glycol, etc.

The polyhydric alcohol component may be almost any polyhydric alcohol containing at least 3 esterifiable hydroxyl groups in order to provide the above described synthesis process advantages of this invention. Mixtures of such polyhydric alcohols may suitably be employed. Suitable polyhydric alcohols include, for example, tris(2-hydroxyethyl) isocyanurate, glycerine, 1,1,1-trimethylolethane, 1,1,1-trimethylolpropane, and their mixtures.

In some cases, useful diamine and dianhydride monomers contain ester groups. Examples of these monomers are diamines such as 4-aminophenyl 4-aminobenzoate, 4-amino-3-methylphenyl-4-aminobenzoate and dianhydrides such as p-phenylene bis(trimellitate) dianhydride.

In some cases, useful diamine and dianhydride monomers contain amide groups. Examples of these monomers are diamines such as 4, 4′-diaminobenzamide (DABAN), and dianhydrides such as N,N′-(2,2′-Bis(trifluoromethyl)-[1,1′-biphenyl]-4,4′-diyl)bis(1,3-dioxo-1,3-dihydroisobenzofuran-5-carboxamide) and N,N′-(9H-Fluoren-9-ylidenedi-4,1-phenylene)bis[1,3-dihydro-1,3-dioxo-5-isobenzofurancarboxamide].

Higher order copolymers having an imide group can include any of the monomers described above.

### Amine Reagents

In one embodiment, an amine reagent, such as a primary or secondary amine, can be used to adhere a polymer layer having a polymer with an imide group to an inorganic substrate. While not being bound to any theory, it is believed that the amine reagent reacts with the imide to create a covalent bond to the imide-containing polymer by creating an amide bond. Previous references of crosslinking reactions indicate this chemistry is facile and can occur at room temperature with primary or secondary amine crosslinking agents (see, for example, Y. Liu et al, J Membr Sci 189 (2001), pp. 231-239).

In one embodiment, an alkoxide-containing amine reagent can also be used, which can directly interact with inorganic surfaces by the interaction of the alkoxide with —SiOH groups. In addition, the amine groups can interact with inorganic surfaces and the —SiOH groups present on the surface to help improve adhesion.

In one embodiment, the imide-containing polymer can have a range of glass transition temperatures (T_{g}'s). Typically, the lamination conditions (heat and applied pressure) will be, as a lower limit, close to the glass transition temperature of the polymer film layer with the lowest T_{g}. In one embodiment, a polymer film layer can have a T_{g} of about 300° C. or less. In one embodiment, lamination is carried out at a temperature in a range of from about 20 degrees below to about 50 degrees above the T_{g} of the polymer film layer with the lowest T_{g}. For amorphous or semi-crystalline polymers, T_{g} can be affected by several parameters. An increase in molecular weight leads to a decrease in chain end concentration resulting in a decreased free volume at the end group region and increase in T_{g}. The insertion of rigid or inflexible groups in the chain or bulky and inflexible side or pendant groups will increase the T_{g} of the polymer due to a decrease in chain mobility. Conversely, imide-containing polymers which contain monomers which are flexible and possess many degrees of freedom will lower T_{g}. For these imide-containing polymers, aliphatic imide diamines such as n-alkyl diamines will increase chain mobility, increase free volume (volume not occupied by the polymer) and lower T_{g}. Likewise, an increase in crosslinking decreases chain mobility, leading to a decrease in free volume and increase in T_{g}. In addition, the presence of polar groups increases intermolecular forces, inter-chain attraction and cohesion, leading to a decrease in free volume resulting in an increase in T_{g}.

In one embodiment, the amines that can be derived from metal alkoxides contain at least one primary or secondary amine; the metal atom can be, for instance, silicon, titanium, aluminum, zirconium, niobium or tantalum. In one embodiment, mixtures of alkoxides and metal alkoxide clusters containing more than one metal cation can also be used. In one embodiment, metal alkoxides containing a primary amine, such as amine-containing alkoxysilanes, can be pre-hydrolyzed to produce amine-containing oligomers, essentially amplifying the number of amines at the interface.

In one embodiment, at least one of a hydrolysis and condensation product of the amine precursor, if it contains an alkoxide group, can be used. As used herein, a “hydrolysis product” or a “hydrosylate” refers to an alkoxide in which at least one of the alkoxide substituents have been replaced by a hydroxyl group. For example, in the case of alkoxysilanes, condensates can form when two hydroxyl groups attached to Si condense to form direct Si—O—Si linkages. In this way, alkoxysilane oligomers can form.

In one embodiment, a hydrosylate and/or condensate can be formed by contacting the amine-containing alkoxide with water. In one embodiment, a hydrosylate and/or condensate can be formed by contacting the amine-containing alkoxide with from about 1 to about 200 moles of water per mole of hydrolyzable functional group bonded to the silicon of the oxysilane.

In one embodiment, hydrosylate and/or condensate can be formed by contacting the oxysilane with water in the presence of a lower alkyl alcohol solvent. Representative lower alkyl alcohol solvents include aliphatic and alicyclic C1-C5 alcohols such as methanol, ethanol, n-propanol, iso-propanol and cyclopentanol. In one embodiment, the lower alkyl alcohol solvent is ethanol or methanol.

In one embodiment, hydrolysate and/or condensate can be formed by contacting the oxysilane with water in the presence of an organic acid that catalyzes hydrolysis of one or more alkoxide substituents and further may catalyze condensation of the resultant hydrosylates. The organic acids catalyze hydrolysis of alkoxide substituents, such as alkoxy and aryloxy, and result in the formation of hydroxyl (silanol) groups in their place. Organic acids comprise the elements carbon, oxygen and hydrogen, optionally nitrogen and sulfur, and contain at least one labile (acidic) proton. Examples of organic acids include carboxylic acids such as acetic acid, maleic acid, oxalic acid, and formic acid, as well as sulfonic acids such as methanesulfonic acid and toluene sulfonic acid. In one embodiment, the organic acids can have a pKₐ of at least about 4.7. In one embodiment an organic acid is acetic acid.

In some embodiments, polyamine oligomers such as polyetheramines (e.g. Jeffamine® products from Huntsman Corp., The Woodlands, Tex.) and other polyamine monomers (e.g. 1,3,5-tris(4-aminophenoxy)benzene) can be used. These reagents are polyamine oligomers that can interact with the polymer film layer surface and with —SiOH and other functional groups on the inorganic substrate surface.

Polyamine siloxanes can also be used to promote adhesion between imide-containing polymer layers and inorganic substrates. Examples include various silamines which are amino-functionalized siloxanes and silicones. Examples include poly[(1,3-(N,N-dimethylamino)-2-propoxy)siloxane], poly[(methyl-3-amino-1-propoxy)siloxane], poly[(1,3-(N,N-dimethylamino)-2-propoxy)siloxane], bis(trimethylsiloxy)-1,3-dimethyl-1,3-(N,N-(1′,e′-dimethylamino)-2′-propoxy)siloxane.

### Crosslinking Precursors

In one embodiment, crosslinking precursors are used in coating solutions that form polymer films. By crosslinking the polymer, the polymer film may have improved mechanical properties, as well as improved chemical resistance. In some embodiments, an amine can be useful as both an amine reagent and a crosslinking precursor. Crosslinking precursors can include polyetheramines, such as Jeffamine® D-230, Jeffamine® D-400, Jeffamine® D-2000, Jeffamine® D-2010, Jeffamine® D-4000, Jeffamine® ED-600, Jeffamine® ED-900, Jeffamine® D-2003, Jeffamine® EDR-148, Jeffamine® THF-100, Jeffamine® THF-170, Jeffamine® SD-2001, Jeffamine® D-205 and Jeffamine® RFD-270.

In one embodiment, crosslinking precursors can include aromatic primary diamines, such as m-xylylene diamine, and p-xylylene diamine.

In one embodiment, crosslinking precursors can include aliphatic primary diamines, such as 1,2-diaminoethane, 1,6-diaminohexane, 1,4-diaminobutane, 1,7-diaminoheptane, 1,8-diaminooctane, 1,9-diaminononane, 1,10-diaminodecane (DMD), 1,11-diaminoundecane, 1,12-diaminododecane (DDD), 1,16-hexadecamethylenediamine, 1,3-bis(3-aminopropyl)-tetramethyldisiloxane, isophoronediamine, bicyclo[2.2.2]octane-1,4-diamine and combinations thereof. Other aliphatic diamines suitable for practicing the invention include those having six to twelve carbon atoms or a combination of longer chain and shorter chain diamines or cycloaliphatic diamines.

In one embodiment, crosslinking precursors can include secondary amines, such as piperazine, N,N′-diisopropylethylenediamine, N,N′-diisopropyl-1,3-propanediamine and N,N′-dimethyl-1,3-propanediamine, and triamines, such as 2,4,6-triaminopyrimidine (TAP), melamine, diethylenetriamine, Jeffamine® T-403, Jeffamine® T-3000, Jeffamine® T-5000. In addition, many diamines that may be used as a diamine monomer for polymers, as described above, may also be useful as crosslinking precursors.

In one embodiment, crosslinking precursors can include one or more amine groups that, individually, are either reactive or passivated towards crosslinking of the polymer. When containing an amine group that is passivated, the crosslinking precursor can subsequently be chemically converted, thermally converted, photo-converted or dissociated to form at least two reactive amines. In one embodiment, a passivated crosslinking precursor that is thermally converted can also function as an amine reagent to adhere the polymer film layer to the inorganic substrate. In one embodiment, a single heating step can be used to both crosslink the polymer and adhere it to the substrate.

In one embodiment, a crosslinking precursor can contain alkyl chains as passivating groups, such as N-alkyl or N,N-dialkyl chains, for example, methyl and tert-butyl chains. In one embodiment, a crosslinking precursor can contain an aromatic passivating group, such as N-aryl and N,N-diaryl groups. In one embodiment, a crosslinking precursor can be a compound that contains a benzyl passivating group. In one embodiment a crosslinking precursor can be a compound that contains a silyl derivative as the passivating group, such as tert-butyldiphenylsilyl. Many functional groups can act as protecting groups for amines towards soluble polymers having an imide group. See, for example, P. G. M. Wuts and T. W. Greene, Greene's Protective Groups in Organic Synthesis, 4th Ed., John Wiley & Sons, Inc. (2007) (“Greene's”).

In one embodiment, a crosslinking precursor can contain carbamates as passivating groups. Carbamate passivating groups can be converted to form reactive amines by a variety of methods. Many carbamates can be converted to form reactive amines through the application of heat at temperatures typically greater than 150° C. A variety of chemical routes can also be used to convert a carbamate functional group to form a reactive amine. For example, the introduction of a base, such as tert-butyl alcohol, or an acid, such as phosphoric acid or trifluoroacetic acid, can be used to convert the carbamate to form a reactive amine. Photo-induced reactions can also be used to cleave carbamates to form reactive amines. A variety of methods of converting a range of carbamates are described in Greene's. In one embodiment, a crosslinking precursor can be a compound that contains carbamate passivating groups that are thermally cleavable, such as tert-butyloxycarbonyl, fluorenylmethoxycarbonyl, and benzyl carbamate, or photo-cleavable, such as 3,5-dimethoxybenzyl carbamate, m-nitrophenyl carbamate, and o-nitrobenzyl carbamate.

In one embodiment, a crosslinking precursor can contain an amide passivating group that can be cleaved to form a reactive amine through the introduction of a different chemical species. For example, the different chemical species can include a base such as sodium or potassium hydroxide, ammonia, or a tertiary amine. In other instances, acids such as hydrochloric acid, or enzymes such as penicillin acylase or α-chymotrypsin can be used to cleave the amide to form a reactive amine.

In one embodiment, a crosslinking precursor containing an amide passivating group can be photo-cleaved, such as by irradiating with 245 nm light, or thermally cleaved at temperatures of greater than 65° C. A broad range of amides, such as those described in Greene's, can be used as crosslinking precursors. In one embodiment, a crosslinking precursor can be a compound that contains an amide passivating group, such as acetamide, trifluoroacetamide, formamide, sulfonamide, such as p-toluenesulfonamide, trichloroacetamide, chloroacetamide, phenylacetamide, 3-phenylpropanamide, 3-pyridylcarboxamide, N-benzoylphenylalanyl, and benzamide.

In one embodiment, a crosslinking precursor can be an ammonium salt made from an acid such as acetic acid, butyric acid, pivalic acid, hydrochloric acid or sulfuric acid. An ammonium salt which can be used to passivate an amine in the crosslinking precursor can be formed by the addition of organic and/or mineral Brønsted acids. The direct reaction of the acid and the crosslinking precursor, containing an amine, will form the ammonium salt. The ammonium salt can be dissociated to allow for crosslinking by the application of heat. The kinetic inhibition is also controlled by the acid-ammonium equilibrium constant. If there is not sufficient acid in solution, as determined by the acid-ammonium equilibrium constant, the ammonium salt can be dissociated to form a reactive amine in the crosslinking precursor. In one embodiment, an ammonium salt can be made from the reaction of the amine with acetic acid or trifluoroacetic acid, and then dissociated with heat.

In one embodiment, the crosslinking precursor is selected from a single multi-functional precursor, a combination of multiple single-functional precursors, or a mixture thereof.

### Polymer Films

In one embodiment, a polymer film containing a polymer having an imide group can be produced by combining a diamine and a dianhydride (monomer or other polyimide precursor form) together with a solvent to form a polyamic acid (also called a polyamide acid) solution. The dianhydride and diamine can be combined in a molar ratio of about 0.90 to 1.10. The molecular weight of the polyamic acid formed therefrom can be adjusted by adjusting the molar ratio of the dianhydride and diamine.

In one embodiment, a polyamic acid casting solution is derived from the polyamic acid solution. The polyamic acid casting solution, and/or the polyamic acid solution, can optionally be combined with conversion chemicals like: (i) one or more dehydrating agents, such as, aliphatic acid anhydrides (acetic anhydride, etc.) and/or aromatic acid anhydrides; and (ii) one or more catalysts, such as, aliphatic tertiary amines (triethyl amine, etc.), aromatic tertiary amines (dimethyl aniline, etc.) and heterocyclic tertiary amines (pyridine, picoline, isoquinoline, etc.). The anhydride dehydrating material it is often used in molar excess compared to the amount of amide acid groups in the polyamic acid. The amount of acetic anhydride used is typically about 2.0-4.0 moles per equivalent (repeat unit) of polyamic acid. Generally, a comparable amount of tertiary amine catalyst is used. Nanoparticles, dispersed or suspended in solvent as described above, are then added to the polyamic acid solution.

In one embodiment, a conversion chemical can be an imidization catalyst (sometimes called an “imidization accelerator”) that can help lower the imidization temperature and shorten the imidization time. Typical imidization catalysts can range from bases such as imidazole, 1-methylimidazole, 2-methylimidazole, 1,2-dimethylimidazole, 2-phenylimidazole, benzimidazole, isoquinoline, substituted pyridines such as methyl pyridines, lutidine, and trialkylamines and hydroxy acids such as isomers of hydroxybenzoic acid. The ratio of these catalysts and their concentration in the polyamic acid layer will influence imidization kinetics and the film properties.

In one embodiment, the polyamic acid solution, and/or the polyamic acid casting solution, is dissolved in an organic solvent at a concentration from about 5.0 or 10% to about 15, 20, 25, 30, 35 or 40% by weight.

The solvated mixture (the polyamic acid casting solution) can then be cast or applied onto a support, such as an endless belt or rotating drum, to give a film. Alternatively, it can be cast on a polymeric carrier such as PET, other forms of Kapton® polyimide film (e.g., Kapton® HN or Kapton® OL films) or other polymeric carriers. Next, the solvent-containing film can be converted into a self-supporting film by heating at an appropriate temperature (thermal curing). The film can then be separated from the support, oriented such as by tentering, with continued heating (drying and curing) to provide a polymer film.

Useful methods for producing polymer films containing a polyimide can be found in U.S. Pat. Nos. 5,166,308 and 5,298,331, which are incorporate by reference into this specification for all teachings therein. Numerous variations are also possible, such as,
(a) A method wherein the diamine components and dianhydride components are preliminarily mixed together and then the mixture is added in portions to a solvent while stirring.
(b) A method wherein a solvent is added to a stirring mixture of diamine and dianhydride components. (contrary to (a) above)
(c) A method wherein diamines are exclusively dissolved in a solvent and then dianhydrides are added thereto at such a ratio as allowing to control the reaction rate.
(d) A method wherein the dianhydride components are exclusively dissolved in a solvent and then amine components are added thereto at such a ratio to allow control of the reaction rate.
(e) A method wherein the diamine components and the dianhydride components are separately dissolved in solvents and then these solutions are mixed in a reactor.
(f) A method wherein the polyamic acid with excessive amine component and another polyamic acid with excessive dianhydride component are preliminarily formed and then reacted with each other in a reactor, particularly in such a way as to create a non-random or block copolymer.
(g) A method wherein a specific portion of the amine components and the dianhydride components are first reacted and then the residual diamine components are reacted, or vice versa.
(h) A method wherein the conversion chemicals (catalysts) are mixed with the polyamic acid to form a polyamic acid casting solution and then cast to form a gel film.
(i) A method wherein the components are added in part or in whole in any order to either part or whole of the solvent, also where part or all of any component can be added as a solution in part or all of the solvent.
(j) A method of first reacting one of the dianhydride components with one of the diamine components giving a first polyamic acid. Then reacting another dianhydride component with another amine component to give a second polyamic acid. Then combining the amic acids in any one of a number of ways prior to film formation.

In one embodiment, the polyamic acid solution can be heated, optionally in the presence of an imidization catalyst, to partially or fully imidize the polyamic acid, converting it to a polymer having an imide group. Temperature, time, and the concentration and choice of imidization catalyst can impact the degree of imidization of the polyamic acid solution. Preferably, the solution should be substantially imidized. In one embodiment, for a substantially polymerized solution, greater than 85%, greater than 90%, or greater than 95% of the amic acid groups are converted to the polymer having an imide group, as determined by infrared spectroscopy.

In one embodiment, the solvated mixture (the substantially imidized solution) can be cast to form a polymer film. In another embodiment, the solvated mixture (the first substantially imidized solution) can be precipitated with an antisolvent, such as water or alcohols (e.g., methanol, ethanol, isopropyl alcohol), and the solid polymer resin can be isolated. For instance, isolation can be achieved through filtration, decantation, centrifugation and decantation of the supernatant liquid, distillation or solvent removal in the vapor phase, or by other known methods for isolating a solid precipitate from a slurry. In one embodiment, the precipitate can be washed to remove the catalyst. After washing, the precipitate may be substantially dried, but need not be completely dry. The polymer precipitate can be re-dissolved in a second solvent, such as methyl isobutyl ketone (MIBK), methyl ethyl ketone (MEK), ethyl acetate, methyl acetate, ethyl formate, methyl formate, tetrahydrofuran, acetone, DMAc, NMP and mixtures thereof, to form a second substantially imidized solution (a casting solution), which can be cast to form a polymer film.

In one embodiment, a substantially polymerized solution is formed using monomers (diamines or dianhydrides) with structural characteristics important for solubility, including flexible linkages, such as, but not limited to, aliphatic spacers, ethers, thioethers, substituted amines, amides, esters, and ketones, weak intermolecular interactions, bulky substitutions, non-coplanarity, non-linearity and asymmetry. Examples of diamines that incorporate some of these characteristics are aliphatic diamines, such as HMD, CHDA and IPDA, and aromatic diamines, such as MTB TFMB, MPD, RODA, BAPP, and 3,4-ODA. Examples of dianhydrides that incorporate some of these characteristics are 6FDA, BPADA, ODPA, DSDA and BODA.

In one embodiment, the solvated mixture (the substantially imidized solution) can be mixed with a crosslinking precursor and a colorant, such as a pigment or a dye, and then cast to form a polymer film. In one embodiment, the colorant may be a low conductivity carbon black. In another embodiment, the solvated mixture (the first substantially imidized solution) can be precipitated with an antisolvent, such as water or alcohols (e.g., methanol, ethanol, isopropyl alcohol). In one embodiment, the precipitate can be washed to remove the catalyst. After washing, the precipitate may be substantially dried, but need not be completely dry. The polymer precipitate can be re-dissolved in a second solvent, such as methyl isobutyl ketone (MIBK), methyl ethyl ketone (MEK), tetrahydrofuran (THF), cyclopentanone, ethyl acetate, acetone, DMAc, NMP and mixtures thereof, to form a second substantially imidized solution (a casting solution). To the second substantially imidized solution, a crosslinking precursor and a colorant can be added, which can then be cast to form a polymer film. In one embodiment, a polymer film contains a crosslinked polymer in a range of from about 80 to about 99 wt %. In some embodiments, the polymer film contains between and including any two of the following: 80, 85, 90, 95 and 99 wt % crosslinked polymer. In yet another embodiment, the polymer film contains about 91 to about 98 wt % crosslinked polymer.

In one embodiment, the substantially imidized polymer solution can be cast or applied onto a support, such as an endless belt or rotating drum, to form a film. Alternatively, it can be cast on a polymeric carrier such as PET, other forms of Kapton® polyimide film (e.g., Kapton® HN or Kapton® OL films) or other polymeric carriers. Next, the solvent-containing film can be converted into a film by heating to partially or fully remove the solvent. In some aspects of the invention, the film is separated from the carrier before drying to completion. Final drying steps can be performed with dimensional support or stabilization of the film. In other aspects, the film is heated directly on the carrier.

In one embodiment, poly(amide-imides) can be formed by the reaction of acyl chlorides with diamines and anhydrides.

In one embodiment, poly(ester-imides), or poly(amide-imides), can be formed using ester-containing, or amide-containing, diamines or dianhydrides in similar processes as those described above. In one embodiment, a poly(ester-imide) can be formed by direct reaction of an ester-containing diamine or dianhydride. In one embodiment, a poly(amide-imide) can be formed by direct reaction of an amide-containing diamine or dianhydride.

In one embodiment, poly(ester-imides) can be formed by esterification of diols with carboxylic acid-containing monomers with imide groups, as described in U.S. Pat. No. 4,383,105.

Crosslinking of the polymer can be determined by a variety of methods. In one embodiment, the gel fraction of polymer may be determined by using an equilibrium swelling method, comparing the weight of a dried film before and after crosslinking. In one embodiment, a crosslinked polymer can have a gel fraction in the range of from about 20 to about 100%, or from about 40 to about 100%, or from about 50 to about 100%, or from about 70 to about 100%, or from about 85 to about 100%. In one embodiment, the crosslinked network can be identified using rheological methods. An oscillatory time sweep measurement at specific strain, frequency, and temperature can be used to confirm the formation of crosslinked network. Initially, the loss modulus (G″) value is higher than the storage modulus (G′) value, indicating that the polymer solution behaves like a viscous liquid. Over time, the formation of a crosslinked polymer network is evidenced by the crossover of G′ and G″ curves. The crossover, referred to as the “gel point”, represents when the elastic component predominates over the viscous.

The casting solution can further comprise any one of a number of additives, such as processing aids (e.g., oligomers), antioxidants, light stabilizers, flame retardant additives, anti-static agents, heat stabilizers, ultraviolet absorbing agents, inorganic fillers or various reinforcing agents. Inorganic fillers can include thermally conductive fillers, metal oxides, inorganic nitrides and metal carbides, and electrically conductive fillers like metals. Common inorganic fillers are alumina, silica, diamond, clay, talc, sepiolite, boron nitride, aluminum nitride, titanium dioxide, dicalcium phosphate, and fumed metal oxides. Low color organic fillers, such as polydialkylfluorenes, can also be used. Common organic fillers include polyaniline, polythiophene, polypyrrole, polyphenylenevinylene, polydialkylfluorenes, carbon black, graphite, multiwalled and single walled carbon nanotubes and carbon nanofibers. In one embodiment, nanoparticle fillers and nanoparticle colloids can be used.

In one embodiment, an electrically conductive filler is carbon black. In one embodiment, the electrically conductive filler is selected from the group consisting of acetylene blacks, super abrasion furnace blacks, conductive furnace blacks, conductive channel type blacks, carbon nanotubes, carbon fibers, fine thermal blacks and mixtures thereof. As described above for low conductivity carbon black, oxygen complexes on the surface of the carbon particles act as an electrically insulating layer. Thus, low volatility content is generally desired for high conductivity. However, it is also necessary to consider the difficulty of dispersing the carbon black. Surface oxidation enhances deagglomeration and dispersion of carbon black. In some embodiments, when the electrically conductive filler is carbon black, the carbon black has a volatile content less than or equal to 1%.

Fillers can have a size of less than 550 nm in at least one dimension. In other embodiments, the filler can have a size of less than 500, less than 450, less than 400, less than 350, less than 300, less than 250, or less than 200 nm (since fillers can have a variety of shapes in any dimension and since filler shape can vary along any dimension, the “at least one dimension” is intended to be a numerical average along that dimension). The average aspect ratio of the filler can be 1 or greater. In some embodiments, the sub-micron filler is selected from a group consisting of needle-like fillers (acicular), fibrous fillers, platelet fillers, polymer fibers, and mixtures thereof. In one embodiment, the sub-micron filler is substantially non-aggregated. The sub-micron filler can be hollow, porous, or solid. In one embodiment, the sub-micron fillers of the present disclosure exhibit an aspect ratio of at least 1, at least 2, at least 4, at least 6, at least 8, at least 10, at least 12, or at least 15 to 1.

In some embodiments, sub-micron fillers are 100 nm in size or less. In some embodiments, the fillers are spherical or oblong in shape and are nanoparticles. In one embodiment, sub-micron fillers can include inorganic oxides, such as oxides of silicon, aluminum and titanium, hollow (porous) silicon oxide, antimony oxide, zirconium oxide, indium tin oxide, antimony tin oxide, mixed titanium/tin/zirconium oxides, and binary, ternary, quaternary and higher order composite oxides of one or more cations selected from silicon, titanium, aluminum, antimony, zirconium, indium, tin, zinc, niobium and tantalum. In one embodiment, nanoparticle composites (e.g. single or multiple core/shell structures) can be used, in which one oxide encapsulates another oxide in one particle.

In one embodiment, sub-micron fillers can include other ceramic compounds, such as boron nitride, aluminum nitride, ternary or higher order compounds containing boron, aluminum and nitrogen, gallium nitride, silicon nitride, aluminum nitride, zinc selenide, zinc sulfide, zinc telluride, silicon carbide, and their combinations, or higher order compounds containing multiple cations and multiple anions.

In one embodiment, solid silicon oxide nanoparticles can be produced from sols of silicon oxides (e.g., colloidal dispersions of solid silicon oxide nanoparticles in liquid media), especially sols of amorphous, semi-crystalline, and/or crystalline silica. Such sols can be prepared by a variety of techniques and in a variety of forms, which include hydrosols (i.e., where water serves as the liquid medium), organosols (i.e., where organic liquids serves as the liquid medium), and mixed sols (i.e., where the liquid medium comprises both water and an organic liquid). See, e.g., descriptions of the techniques and forms disclosed in U.S. Pat. Nos. 2,801,185, 4,522,958 and 5,648,407. In one embodiment, the nanoparticle is suspended in a polar, aprotic solvent, such as, DMAc or other solvent compatible with polyamic acid or poly(amide amic acid). In another embodiment, solid nanosilica particles can be commercially obtained as colloidal dispersions or sols dispersed in polar aprotic solvents, such as for example DMAC-ST (Nissan Chemical America Corporation, Houston Tex.), a solid silica colloid in dimethylacetamide containing less than 0.5 percent water, with 20-21 wt % SiO₂, with a median nanosilica particle diameter, d₅₀, of about 16 nm.

In one embodiment, sub-micron fillers can be porous and can have pores of any shape. One example is where the pore comprises a void of lower density and low refractive index (e.g., a void-containing air) formed within a shell of an oxide such as silicon oxide, i.e., a hollow silicon oxide nanoparticle. The thickness of the sub-micron fillers shell affects the strength of the sub-micron fillers. As the hollow silicon oxide particle is rendered to have reduced refractive index and increased porosity, the thickness of the shell decreases resulting in a decrease in the strength (i.e., fracture resistance) of the sub-micron fillers. Methods for producing such hollow silicon oxide nanoparticles are known, for example, as described in Japanese Patent Nos. 4406921B2 and 4031624B2. Hollow silicon oxide nanoparticles can be obtained from JGC Catalysts and Chemicals, LTD, Japan.

In one embodiment, sub-micron fillers can be coated with a coupling agent. For example, a nanoparticle can be coated with an aminosilane, phenylsilane, acrylic or methacrylic coupling agents derived from the corresponding alkoxysilanes. Trimethylsilyl surface capping agents can be introduced to the nanoparticle surface by reaction of the sub-micron fillers with hexamethyldisilazane. In one embodiment, sub-micron fillers can be coated with a dispersant. In one embodiment, sub-micron fillers can be coated with a combination of a coupling agent and a dispersant. Alternatively, the coupling agent, dispersant or a combination thereof can be incorporated directly into the polymer film and not necessarily coated onto the sub-micron fillers.

The thickness of the polymer film may be adjusted, depending on the intended purpose of the film or final application specifications. In one embodiment, the polyimide film has a total thickness in a range of from about 10 to about 80 μm, or from about 10 to about 25 μm, or from about 15 to about 25 μm.

In one embodiment, the polymer film has a b* of less than about 1.25, or less than about 1.0 or less than about 0.8 for a film thickness of about 25 μm, when measured with a dual-beam spectrophotometer, using D65 illumination and 10-degree observer, in total transmission mode over a wavelength range of 360 to 780 nm. In one embodiment, the polymer film has a yellowness index (YI) of less than about 2.25, or less than about 2.0 or less than about 1.75 for a film thickness of about 25 μm, when measured using the procedure described by ASTM E313.

### Inorganic Substrates

In one embodiment, articles can include polymer films layers used in combination with inorganic substrates. In one embodiment, inorganic substrates can be inorganic materials containing silicon and oxygen. Inorganic substrates can be crystalline inorganic materials or amorphous. Substrates can be films or layers, or other shapes (e.g., wedges, prisms), including any angular or curved geometric shape. Substrates can be rods, cylinders or plates. Autoclave lamination process can be especially suited to bonding non-planar materials to non-planar substrates. In one embodiment, inorganic substrates can include ceramic, glass or glass-ceramic materials, or mixtures thereof.

In one embodiment, ceramic substrates containing silicon and oxygen can include oxides, nitrides or oxy-nitrides, phosphides or oxyphosphides, carbides or oxycarbides. In some cases, the substrate may comprise a silicon oxide surface but have a different bulk composition away from the surface of the substrate. For instance, a Si₃N₄ or a SiC substrate can be hydrolyzed or oxidized so that it contains silicon and oxygen at the surface. Multilayer inorganic substrates can also be used. Coatings of silicon oxide or silicon- and oxygen-containing inorganic species can be used on inorganic substrates. Coatings can be formed in a variety of ways, including physical vapor deposition, sputtering, atomic layer deposition and the like. Coatings can also be made, which contain silicon and oxygen, by liquid-based coating processes (spray coating, slot die coating, bar coating), for instance using an alkoxysilane as one component in the coating. The surface on the inorganic substrate does not have to have exclusively silicon and oxygen. A mixed phase or combination of phases can be used, as long as the surface includes silicon and oxygen.

In one embodiment, inorganic substrates can be glass substrates of various shapes and geometries. The term “glass” as used herein is meant to include any material made at least partially of glass, including glass and glass-ceramics. “Glass-ceramics” include materials produced through controlled crystallization of glass. In some embodiments, glass-ceramics have about 30% to about 90% crystallinity. Non-limiting examples of glass-ceramic systems that may be used include Li₂O×Al₂O₃×nSiO₂ (i.e., LAS systems), MgO×Al₂O₃×nSiO₂ (i.e., MAS systems), and ZnO×Al₂O₃×nSiO₂ (i.e., ZAS systems).

In one or more embodiments, the inorganic substrate may include glass, which may be strengthened or non-strengthened. Examples of suitable glass include soda lime glass, alkali aluminosilicate glass, alkali-containing borosilicate glass and alkali aluminoborosilicate glass. In some variants, the glass may be free of lithia. In one or more alternative embodiments, the substrate may include crystalline substrates such as glass-ceramic substrates (which may be strengthened or non-strengthened) or may include a single crystal structure, such as sapphire. In one or more specific embodiments, the substrate includes an amorphous base (e.g., glass) and a crystalline cladding (e.g., sapphire layer, a polycrystalline alumina layer and/or or a spinel (MgAl₂O₄) layer.

A substrate or layer may be strengthened to form a strengthened substrate or layer. As used herein, the terms “strengthened substrate” or “strengthened layer” may refer to a substrate and/or layer that has been chemically strengthened, for example through ion-exchange of larger ions for smaller ions in the surface of the substrate and/or layer. Other strengthening methods known in the art, such as thermal tempering, or utilizing a mismatch of the coefficient of thermal expansion between portions of the substrate and/or layer to create compressive stress and central tension regions, may also be utilized to form strengthened substrates and/or layers.

Where the substrate and/or layer is chemically strengthened by an ion exchange process, the ions in the surface layer of the substrate and/or layer are replaced by, or exchanged with, larger ions having the same valence or oxidation state. Ion exchange processes are typically carried out by immersing a substrate and/or layer in a molten salt bath containing the larger ions to be exchanged with the smaller ions in the substrate. It will be appreciated by those skilled in the art that parameters for the ion exchange process, including, but not limited to, bath composition and temperature, immersion time, the number of immersions of the substrate and/or layer in a salt bath (or baths), use of multiple salt baths, additional steps such as annealing, washing, and the like, are generally determined by the composition of the substrate and/or layer and the desired compressive stress (CS), depth of compressive stress layer (or depth of layer) of the substrate that result from the strengthening operation. By way of example, ion exchange of alkali metal-containing glass substrates and/or layers may be achieved by immersion in at least one molten bath containing a salt such as, but not limited to, nitrates, sulfates, and chlorides of the larger alkali metal ion. The temperature of the molten salt bath typically is in a range from about 380° C. up to about 450° C., while immersion times range from about 15 minutes up to about 40 hours. However, temperatures and immersion times different from those described above may also be used.

In addition, non-limiting examples of ion exchange processes in which glass substrates and/or layers are immersed in multiple ion exchange baths, with washing and/or annealing steps between immersions, are described in U.S. Pat. No. 8,561,429, in which glass substrates are strengthened by immersion in multiple, successive, ion exchange treatments in salt baths of different concentrations; and U.S. Pat. No. 8,312,739, in which glass substrates are strengthened by ion exchange in a first bath that is diluted with an effluent ion, followed by immersion in a second bath having a smaller concentration of the effluent ion than the first bath.

In one embodiment, a solution having amine reagent containing silicon is used to treat an inorganic substrate using a dip coating process. The amine reagent containing silicon can have alkoxide groups. The amine reagent includes a primary or secondary amine, and after drying, the inorganic substrate has an amine-functional surface. Subsequently, the substrate can be laminated with heat and pressure to a polymer film, which includes a polymer having an imide group. The amine on the inorganic surface may react with the polymer to form an amide and provide siloxane linkages to the substrate.

### Lamination

The adhesion of the polymer films can be accomplished by heating while applying pressure in a hydraulic press. Typically, the highest temperature achieved during the lamination process is not less than 20° C. below the T_{g} of the polymer film layer with the lowest T_{g}. Higher temperatures can be used for the lamination, but at temperatures greater than 50° C. above the T_{g} of the polymer with the lowest T_{g}, some discoloration of the film can occur if the residence time at the higher temperature is five minutes or more. Hence, higher temperature lamination may require residence times shorter than 5 minutes. Lamination in the hydraulic press can be in air or under vacuum to help remove trapped air. The amine reagent can be applied to a surface of one of the polymer films, or to one surface of each polymer film. Any method to contact the polymer film with a soluble amine reagent can be used, including bar coating, slot die coating, spray coating, dip coating, spin coating or other liquid coating methods. In one embodiment, a surface of the polymer film layer(s) may be plasma treated or corona treated before lamination to further enhance the adhesion of the polymer film layers. Any plasma or corona treatment will be performed before treatment with an amine reagent. In one embodiment, lamination is carried out at a temperature in a range of from about 20 degrees below to about 50 degrees above the T_{g} of the polymer film layer with the lowest T_{g}.

In one embodiment, polymer film layers can be adhered using an autoclave lamination process. An autoclave is a high-temperature pressure vessel which can be used to produce laminate structures in a batch process. The laminate components are assembled prior to loading the pressure vessel chamber and are arranged in such a way that they do not move while under heat and pressure. The process generally operates using air or an inert gas such as argon or nitrogen to provide the pressure to laminate the materials inside the pressure vessel chamber. The gas inside is then heated and cooled through different cycles using a heat exchanger to maintain different temperature and pressure profiles for set periods of time. In one embodiment, process cycles will range from about 100 to about 400 psig and from about 100 to about 400° C. with total cycle time accumulating up to about 30 hours. After the cycles are complete and the chamber is returned to ambient temperature and pressure the contents are removed. In one embodiment, autoclave lamination is carried out at a temperature in a range of from about 20 degrees below to about 50 degrees above the T_{g} of the polymer film layer with the lowest T_{g}.

In one embodiment, a roll-to-roll process may be used to form the laminate articles of the present invention. In such a process, the polymer film layers are supplied from rolls and first pass over tension rolls. Either one or both surfaces to be laminated to form the interface between the layers can be treated with the amine reagent.

In one embodiment, nip-roll lamination may be used, wherein nip rolls may be heated to promote bonding of the polymer film layers. The bonding pressure exerted by the nip rolls may vary with the film materials, the polymeric materials, and the temperatures employed. Proper control of the speed and the tension will minimize wrinkling of the film. In one embodiment, the temperature of the nip rolls is in a range of from about 20 degrees below to about 50 degrees above the T_{g} of the polymer film layer with the lowest T_{g}.

After bonding, the laminate is passed over a series of cooling rolls which ensure that the laminate taken up on a roll is not tacky. Process water cooling is generally sufficient to achieve this objective. Tension within the system may be further maintained using idler rolls. Laminate articles made through this process will have sufficient strength to allow for further handling by laminators that may add additional layers to the laminate.

In one embodiment, any number of polymer film layers may be laminated together using amine reagents to improve the adhesion between some or all of the layers. In one embodiment, a combination of polymer film layers and one or more inorganic substrates may be laminated together using amine reagents to improve the adhesion between some or all of the layers.

In one embodiment, a multilayer polymer film can be formed in which some layers are first formed using a coextrusion or coating process, and then a lamination process using amine reagents is used to add additional layers, or to combine any number of multilayer polymer films. In some embodiments a coextrusion process can used to form a multilayer polymer film with an inner core layer sandwiched between two outer layers. In this process, a finished polyamic acid solution is filtered and pumped to a slot die, where the flow is divided in such a manner as to form the first outer layer and the second outer layer of a three-layer coextruded film. In some embodiments, a second stream of polyimide is filtered, then pumped to a casting die, in such a manner as to form the middle polyimide core layer of a three-layer coextruded film. The flow rates of the solutions can be adjusted to achieve the desired layer thickness.

In some embodiments, the multilayer film is prepared by simultaneously extruding the first outer layer, the core layer and the second outer layer. In some embodiments, the layers are extruded through a single or multi-cavity extrusion die. In another embodiment, the multilayer film is produced using a single-cavity die. If a single-cavity die is used, the laminar flow of the streams should be of high enough viscosity to prevent comingling of the streams and to provide even layering. In some embodiments, the multilayer film is prepared by casting from the slot die onto a moving stainless-steel belt. In one embodiment, the belt is then passed through a convective oven, to evaporate solvent and partially imidize the polymer, to produce a “green” film. The green film can be stripped off the casting belt and wound up. The green film can then be passed through a tenter oven to produce a fully cured polyimide film. In some embodiments, during tentering, shrinkage can be minimized by constraining the film along the edges (i.e., using clips or pins). In one embodiment, this three-layer, coextruded polymer film can then be further laminated using amine reagents to one or more additional polymer layers, to inorganic substrates, or to additional polymer layers and inorganic substrates.

### Metal-Clad Laminates

In one embodiment, an article having multiple polymer films can be used to form a metal-clad laminate. In one embodiment, a conductive layer for a metal-clad laminate can be created by:

i. metal sputtering (optionally, then electroplating);

ii. foil lamination; and/or

iii. any conventional or non-conventional method for applying a thin metallic layer to a substrate.

Metal-clad laminates can be formed as single-sided laminates or double-sided laminates by any number of well-known processes. In one embodiment, a lamination process may be used to form a metal-clad laminate with a multilayer polymer film. In one embodiment, a first outer layer of the multilayer polymer film includes a first thermoplastic polymer and is placed between a first conductive layer and a core layer, and a second outer layer includes a second thermoplastic polymer and is placed on the opposite side of the core layer. In one embodiment, a second conductive layer is placed in contact with the second outer layer on a side opposite the core layer. One advantage of this type of construction is that the lamination temperature of the multilayer film is lowered to the lamination temperature necessary for the thermoplastic polymer of the outer layer to bond to a conductive layer(s). In one embodiment, the conductive layer(s) is a metal layer(s).

For example, prior to the step of applying a polymer film onto a metal foil, the polymer film can be subjected to a pre-treatment step. Pre-treatment steps can include, heat treatment, corona treatment, plasma treatment under atmospheric pressure, plasma treatment under reduced pressure, treatment with coupling agents like silanes and titanates, sandblasting, alkali-treatment, acid-treatments, and coating polyamic acids. To improve the adhesion strength, it is generally also possible to add various metal compounds as disclosed in U.S. Pat. Nos. 4,742,099; 5,227,244; 5,218,034; and 5,543,222, incorporated herein by reference.

In addition, (for purposes of improving adhesion) the conductive metal surface may be treated with various organic and inorganic treatments. These treatments include using silanes, imidazoles, triazoles, oxide and reduced oxide treatments, tin oxide treatment, and surface cleaning/roughening (called micro-etching) via acid or alkaline reagents.

As used herein, the term “conductive layers” and “conductive foils” mean metal layers or metal foils (thin compositions having at least 50% of the electrical conductivity of a high-grade copper). Conductive foils are typically metal foils. Metal foils do not have to be used as elements in pure form; they may also be used as metal foil alloys, such as copper alloys containing nickel, chromium, iron, and other metals. The conductive layers may also be alloys of metals and are typically applied to the polyimides of the present invention via a sputtering step followed by an electro-plating step. In these types of processes, a metal seed coat layer is first sputtered onto a polymer film. Finally, a thicker coating of metal is applied to the seed coat via electro-plating or electro-deposition. Such sputtered metal layers may also be hot pressed above the glass transition temperature of the polymer for enhanced peel strength.

Particularly suitable metallic substrates are foils of rolled, annealed copper or rolled, annealed copper alloy. In many cases, it has proved to be advantageous to pre-treat the metallic substrate before coating. This pre-treatment may include, but is not limited to, electro-deposition or immersion-deposition on the metal of a thin layer of copper, zinc, chrome, tin, nickel, cobalt, other metals, and alloys of these metals. The pre-treatment may consist of a chemical treatment or a mechanical roughening treatment. It has been found that this pre-treatment enables the adhesion of the polymer layer and, hence, the peel strength to be further increased. Apart from roughening the surface, the chemical pre-treatment may also lead to the formation of metal oxide groups, enabling the adhesion of the metal to a polyimide layer to be further increased. This pre-treatment may be applied to both sides of the metal, enabling enhanced adhesion to substrates on both sides.

In one embodiment, a metal-clad laminate can include an article that is a multilayer polymer film and a first metal layer adhered to an outer surface of the first outer layer of the multilayer film. In one embodiment, a metal-clad laminate can include a second metal layer adhered to an outer surface of the second outer layer of the multilayer film. In one embodiment, the first metal layer, the second metal layer or both metal layers can be copper. In one embodiment, a metal-clad laminate of the present invention comprising a double-side copper-clad can be prepared by laminating copper foil to both sides of the multilayer film.

### Applications

In one embodiment, articles having polymer film layers can be used for a number of electronic device applications, such as in an organic electronic device. For example, layers including device substrates, touch panels, substrates for color filter sheets, cover films, and others can be formed in a multilayer arrangement in the device. The particular materials' properties requirements for each layer are unique and may be addressed by appropriate choice of a polymer for each layer. Organic electronic devices that may benefit from having an article having multiple polymer film layers include, but are not limited to, (1) devices that convert electrical energy into radiation (e.g., a light-emitting diode, light emitting diode display, lighting device, luminaire, or diode laser), (2) devices that detect signals through electronics processes (e.g., photodetectors, photoconductive cells, photoresistors, photoswitches, phototransistors, phototubes, IR detectors, biosensors), (3) devices that convert radiation into electrical energy, (e.g., a photovoltaic device or solar cell), (4) devices that convert light of one wavelength to light of a longer wavelength, (e.g., a down-converting phosphor device); and (5) devices that include one or more electronic components that include one or more organic semi-conductor layers (e.g., a transistor or diode).

In one embodiment, a metal-clad laminate having multiple polymer film layers may be useful for die pad bonding of flexible print connection boards or semiconductor devices or packaging materials for CSP (chip scale package), chip on film (COF), COL (chip on lead), LOC (lead on chip), multi-chip module (“MCM”), ball grid array (“BGA” or micro-ball grid array), and/or tape automated bonding (“TAB”).

In another embodiment, articles having polymer film layers are useful for wafer level integrated circuit packaging, where a composite is made using a polyimide film interposed between a conductive layer (typically a metal) having a thickness of less than 100 μm, and a wafer comprising a plurality of integrated circuit dies. In one (wafer level integrated circuit packaging) embodiment, the conductive passageway is connected to the dies by a conductive passageway, such as a wire bond, a conductive metal, a solder bump or the like.

In one embodiment, articles having inorganic substrates and polymer film layers, such as glass or ceramic laminates, can be used as impact-resistant laminates for structural, or architectural, applications, such as hurricane-resistant windows, theft-resistant panels and blast-resistant structures. For example, glass beams, composed of laminated glass, usually provide poor post-breakage robustness if all plies are broken. Articles that combine inorganic substrates with ductile polymer layers can improve the structural performance after failure and expand the scope of applications for these laminates. In one embodiment, structural laminates having inorganic substrates and polymer film layers can also be used as sound-reducing laminates, such as sound insulating panels.

In one embodiment, articles having inorganic substrates and polymer film layers can be used in applications for penetration-resistant laminates, such as bulletproof glass and armor. For example, bulletproof glass is a strong and optically transparent material that is particularly resistant to penetration by projectiles and can benefit from the less rigid properties of the polymer layer in a multilayer film. In one embodiment, a ceramic substrate, such as single-crystal sapphire, aluminum oxynitride or other oxynitrides and spinel ceramics, can be laminated to a polymer film layer and used as transparent armor. In some cases, these ceramic laminates can greatly reduce the weight of armor while providing the same penetration resistance as glass laminates.

In one embodiment, articles having inorganic substrates and polymer film layers can be used in architectural applications or transportation application where a combination of impact resistance, penetration resistance and sound reduction are desired. For example, a windshield on a vehicle may include one or more inorganic substrates and one or more polymer film layers that provide the windshield with a desired impact resistance, penetration resistance and sound insulation.

In one embodiment, articles having inorganic substrates and polymer film layers can be used as panels for electronic devices, such as displays for consumer electronic devices.

The advantageous properties of this invention can be observed by reference to the following examples that illustrate, but do not limit, the invention. All parts and percentages are by weight unless otherwise indicated.

### EXAMPLES

### Test Methods

### Measurement of CIE L*, a*, b* Color

Color measurements were performed using a ColorQuest® XE dual-beam spectrophotometer (Hunter Associates Laboratory, Inc., Reston, Va.), using D65 illumination and 10 degree observer, in total transmission mode over a wavelength range of 380 to 780 nm. Percent haze and transmittance were also measured using this instrument.

### Thickness

Film thickness was determined by measuring 5 positions across the profile of the film using a contact-type FISCHERSCOPE MMS PC2 modular measurement system thickness gauge (Fisher Technology Inc., Windsor, Conn.).

### Examples 1 and 2 and Comparative Example 1

For a first polymer layer, with a monomer composition of 6FDA 1.0//TFMB 0.75/HMD 0.25 (molar equivalents), into a 500-ml reaction vessel, equipped with mechanical stirring and nitrogen purged atmosphere, 298.2 g anhydrous DMAc and 50.0 g of 4,4′-(hexafluoroisopropylidene)diphthalic anhydride (6FDA, Synasia Inc., Metuchen, N.J.) was added. 25.03 g of trifluoromethylbenzidine (TFMB, Seika Corp., Wakayam Seika Kogyo Co., LTD., Japan) and 3.27 g of 1,6-diaminohexane (HMD, TCI America, Portland, Oreg.) were added slowly over a period of 20 minutes. The reaction mixture was stirred and heated at 40° C. for 16 hours. The solution became slightly viscous. Films were prepared by doctor blade coating the polyamic-acid solution onto glass treated with a release agent. The polyamic-acid films were dried at 80° C. to form a film of approximately 70 to 80 wt % solids. The film was then cured in an oven from 150° C. to 300° C. over the course of 20 minutes.

For a second polymer layer, with a monomer composition of BPDA 0.1/6FDA 0.9//TFMB 1.0, 15.519 kg of TFMB and 175.398 kg of DMAc were added to a nitrogen purged 80-gallon reactor while stirring. The solution was stirred to completely dissolve the TFMB in the DMAc solvent and stirring continued during all subsequent steps. The reaction mixture was heated to ˜40° C. for this procedure. 1.398 kg of biphenyl tetracarboxylic acid dianhydride (BPDA, Mitsubishi Chemical Co., Japan) and 19.007 kg of 6FDA were added over a 6 hours period. The viscosity of the pre-polymer was ˜1.5 poise at 25° C.

A portion of the polymer was polymerized (“finished”) to ˜376.9 poise by adding a mixture of 6FDA and BPDA powders in DMAc in a nitrogen purged reactor. The material was polymerized with adding 6FDA/BPDA monomers over the course of approximately 24 hours at 40° C.

147.6 kg of this polymer solution was combined with 2.9 kg of a 25 wt % solution of 1,2-dimethylimidazole in DMAc and an additional 28.6 kg of DMAc. The viscosity was 500 poise. The material was filtered through 20-micron filter media and cast onto a 3-mil heat-stabilized PET film in a roll to roll process. A peak temperature of ˜138° C. was used to drive off solvent and create a green film which contained some residual DMAc (50-90 wt % solids). The dry thickness target after completely removing solvent would produce a 2.8 mil film. 1.42 mil PET was used as a coversheet to protect the surface of the green film.

The dried film was peeled from the belt and heated with radiant heaters in a tenter oven at a temperature of from about 110 to about 655° C. (radiant heater surface temperature) to dry and imidize the polymer film.

For Comparative Examples 1 (CE1), no silane treatment was performed on either of the polymer film layers.

For Examples 1 and 2 (E1-E2), a silane solution for pretreating surfaces of the polymer films was prepared. MeOH/H₂O (95/5 v/v) was added to 3-(2-aminoethylamino) propyltrimethoxysilane (AEAPTMS) to form a 1 wt % AEAPTMS solution, which was rolled for 1-2 hours. For E1, only a surface of the first polymer layer was pretreated. For E2, a surface of the first polymer layer and a surface of the second polymer layer were each pretreated.

### Polyimide Film—Polyimide Film Lamination

For E1-E2 and CE1, the polymer film to polymer film was formed in the following manner. The polyimide films were submerged in isopropyl alcohol and allowed to air dry in a clean environment. Each treated sample was coated on one side using a squeegee and excess pre-treatment solution was immediately rinsed with 100% methanol. The samples were coated to allow release on one edge by leaving the surface clean and without pre-treatment. Compressed air was used to evaporate excess methanol. Afterwards each film sample with applied treatment was soft baked for 15 minutes at 110° C. on a hot plate with a piece of clean glass acting as a buffer to keep the surface of the films clean. A sandwich construction was assembled which included: metal plate (14″×14″)/reinforced silicone rubber sheet/metal plate/buffer polyimide film/FEP/Sample (2 polyimide films)/FEP/buffer polyimide film/metal plate/reinforced silicone rubber sheet/metal plate. The sandwich was loaded into a 15″×15″ Wabash Press (Model GS30H-15-CX, Wabash MPI, Wabash, Ind.) and the platens were closed. The sample was heated for a predetermined time under vacuum, allowed to cool in the press, and removed from the press. Table 1 lists the temperature, pressure and time for each sample. To test for adhesion, the untreated edge of each sample was used as a tab to manually pull apart the laminate. A “pass” indicates that the laminate was resistant to separation, while a “fail” indicates that the laminate readily pulled apart with little resistance.

TABLE 1

| | | T | Pₘₐₓ | Total Time | |
|---|---|---|---|---|---|
| Example | Pretreatment | (° C.) | (psig) | (minutes) | Adhesion |
| CE1 | None | 232 | 290 | 130 | Fail |
| E1 | 1^{st} polymer layer | 232 | 290 | 130 | Pass |
| E2 | Both polymer layers | 232 | 290 | 130 | Pass |

X-ray photoelectron spectroscopy (XPS) analyses were performed using a scanning XPS microprobe (PHI Quantera, Physical Electronics, Inc., Chanhassen, Minn.). Each sample surface was first examined by a broad survey scan to determine what elements were present on the surface. High resolution spectra were acquired to determine the chemical states of the detected elements and their atomic concentrations. The XPS instrument was under ultra-high vacuum with base pressure less than ˜5×10⁻¹⁰ torr and operated with a monochromatic AI X-ray source. All experiments were performed at a 45° exit angle with the analytical area at 200 μm×200 μm. A hemi-spherical analyzer was used to collect photoelectrons. PHI MultiPak@software version 9.3 was used for data analysis.

For Comparative Example 2 (CE2), the first and second polymer film layers, as described above, were both pretreated and soft baked, but were not laminated together. Table 2 summarized the XPS data, in atomic percent, of the interface surfaces created after peeling apart the laminated films. The silane treated surfaces show the presence of Si and higher N/F ratios compared to the untreated surfaces. For E1, silane appeared to stay primarily on the treated first polymer layer after peeling. For E2, where both polymer film layers were pretreated, the silane is present on both surfaces from the interface after peeling. The presence of Si on both surfaces in these examples indicates that the surfaces being examined are indeed the interfaces between the two layers.

TABLE 2

| | 1^{st} polymer layer | | | | 2^{nd} polymer layer | | | |
|---|---|---|---|---|---|---|---|---|
| Example | N | F | N/F | Si | N | F | N/F | Si |
| CE1 | 4.0 | 22.2 | 0.18 | 0 | 3.6 | 23.2 | 0.16 | 0 |
| E1 | 4.6 | 21.6 | 0.21 | 0.7 | 3.8 | 23.4 | 0.16 | <0.1 |
| E3 | 4.5 | 21.8 | 0.21 | 0.5 | 4.2 | 22.8 | 0.18 | 0.4 |
| CE2 | 4.7 | 20.0 | 0.24 | 0.6 | 4.2 | 21.4 | 0.20 | 0.4 |

TOF-SIMS surface spectrometry was performed using a TOF-SIMS M6 (IONTOF GmbH, Muenster, Germany) equipped with a 30 keV Bi primary ion beam and a pulsed flood gun for charge neutralization. Analysis areas were constrained to 500×500 μm², while maintaining a primary ion dose density of 10¹² ions/cm² or below to ensure static SIMS conditions (probe depth of 2 nm).

In particular, the polymer layers that were pretreated showed a relatively higher surface content of CN⁻ species. The peak area of the secondary ion of interest (CN⁻) is normalized by a characteristic peak that represent the matrix materials. For polyimide films, fragment ion peaks, molecular ion peaks, or hydrocarbon peaks such as C₃N⁻, C₇⁻, CF₃⁻, C₇H₄NO⁻ can be used. The relative peak area ratios from similar samples can be calculated to compare the relative amounts of related species. The normalized peak area ratios of the pretreated layers showed a greater than 10% increase for CN⁻ related species when treating the polymer film layers with an amine reagent prior to lamination. This can be assigned to the formation of additional C—N bonds and/or species with amide functional groups at the interface.

$$Relative peak area ratio = \frac{Intensity of {CN}^{-}}{Intensity of a characteristic peak from matrix}$$

TABLE 3

| | 1^{st} polymer layer | | 2^{nd} polymer layer | |
|---|---|---|---|---|
| | CN/C₃N | Change | CN/C₃N | Change |
| Example | ratio | (%) | ratio | (%) |
| CE1 | 13.6 | — | 13.1 | — |
| E1 | 17.2 | 26 | 13.3 | 2 |
| E2 | 20.1 | 48 | 16.7 | 27 |

Note that not all of the activities described above in the general description are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that various modifications and changes can be made without departing from the scope of the invention as set forth in the claims below. All features disclosed in this specification may be replaced by alternative features serving the same, equivalent or similar purpose. Accordingly, the specification is to be regarded in an illustrative rather than a restrictive sense and all such modifications are intended to be included within the scope of the invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

What is claimed is:

1. An article comprising:
a first polymer film layer comprising a first polymer comprising a first imide group; and
a second polymer film layer comprising a second polymer comprising a second imide group, wherein, after separating the first and second polymer film layers at an interface between the layers to expose a first interfacial surface of the first polymer film layer and a second interfacial surface of the second polymer film layer:
(a) a ratio of CN⁻ to C₃N⁻ species at the first interfacial surface, as measured using negative secondary ion mass spectroscopy is at least 10% higher than it is in the bulk of the first polymer film layer;
(b) a ratio of CN⁻ to C₃N⁻ species at the second interfacial surface, as measured using negative secondary ion mass spectroscopy is at least 10% higher than it is in the bulk of the second polymer film layer; or
(c) a ratio of CN⁻ to C₃N⁻ species at the first interfacial surface, as measured using negative secondary ion mass spectroscopy is at least 10% higher than it is in the bulk of the first polymer film layer and a ratio of CN⁻ to C₃N⁻ species at the second interfacial surface, as measured using negative secondary ion mass spectroscopy is at least 10% higher than it is in the bulk of the second polymer film layer.

2. The article of claim 1, wherein the first and second polymers comprising an imide group are each individually selected from the group consisting of polyimides, poly(amide-imides), poly(ether-imides), poly(ester-imides), copolymers comprising amide, ester or ether groups, and mixtures thereof.

3. The article of claim 2, wherein the polyimide is derived from a dianhydride, a fluorinated aromatic diamine and an aliphatic diamine.

4. The article of claim 3, wherein the dianhydride comprises an alicyclic dianhydride.

5. The article of claim 1, wherein:
(a) the first polymer film layer has a T_{g} of 300° C. or less;
(b) the second polymer film layer has a T_{g} of 300° C. or less; or
(c) both the first and second polymer film layers have T_{g}'s of 300° C. or less.

6. The article of claim 1, wherein the article has a b* of 1.25 or less and a yellowness index of 2.25 or less when measured using the procedure described by ASTM E313 at a thickness of 25 μm.

7. The article of claim 1, wherein the article has a haze of 15% or less and an L* of 93 or more when measured at a thickness of 25 μm.

8. The article of claim 1, further comprising an inorganic substrate in contact with the first polymer film layer on a side opposite the second polymer film layer.

9. An impact-resistant article comprising the article of claim 1.

10. A penetration-resistant article comprising the article of claim 1.

11. A sound-reducing article comprising the article of claim 1.

12. A metal-clad laminate comprising the article of claim 1.

13. A process for forming an article, wherein the article comprises:
a first polymer film layer comprising a first polymer having a first glass transition temperature and comprising a first imide group; and
a second polymer film layer comprising a second polymer having a second glass transition temperature and comprising a second imide group, wherein the first glass transition temperature is the same or lower than the second glass transition temperature and the process comprises:
(a) applying an amine reagent to a surface of the first polymer film layer, a surface of the second polymer film layer, or both;
(b) contacting the polymer film layers, such that a surface having an amine reagent is at an interface between the polymer film layers; and
(c) applying heat and pressure to the article.

14. The process of claim 13, wherein the amine reagent is selected from the group consisting of primary amines, secondary amines, or a mixture thereof.

15. The process of claim 13, wherein the amine reagent comprises a polyamine.

16. The process of claim 13, wherein the amine reagent comprises a metal alkoxide comprising a hydrolyzed oligomer.

17. The process of claim 13, wherein the amine reagent applied to the surface of the first polymer film layer is the same or different than the amine reagent applied to the surface of the second polymer film layer.

18. The process of claim 13, wherein heat is a temperature in a range of from 20 degrees below to 50 degrees above the glass transition temperature of the first polymer.

19. The process of claim 13, wherein the amine reagent comprises an amine group that has been passivated and can be thermally activated by applying heat.

20. The process of claim 19, wherein the amine group that has been passivated can, upon activation, also crosslink the first polymer, the second polymer, or both.

21. The process of claim 13, wherein before applying the amine reagent to the surface of one or both polymer film layer(s), the surface of one or both polymer film layer(s) undergoes a corona treatment or a plasma treatment.

22. The process of claim 13, wherein:
the article further comprises an inorganic substrate in contact with the first polymer film layer on a side opposite the second polymer film layer;
during step (a) an amine reagent is also applied to the other surface of the first polymer film layer, a surface of the inorganic substrate, or both; and
during step (b) the first polymer film layer and the inorganic substrate are contacted such that a surface having an amine reagent is at an interface between the first polymer film layer and the inorganic substrate.
